(19) United States
(12) Patent Application Publication
(10) Pub. No.: US 2012/0210831 A1
(43) Pub. Date: Aug. 23, 2012

(54) FEEDING DEVICE OF SCREW GUN

(75) Inventor: CHIA-SHENG LIANG, Bali Shiang (TW)

(73) Assignee: DE POAN PNEUMATIC CORP.

(21) Appl. No.: 13/031,244

(22) Filed: Feb. 20, 2011

(51) Int. Cl. B25B 23/04

(52) U.S. Cl. 81/434

(57) ABSTRACT

A screw feeding device of a screw gun includes a guiding cover assembled at the bottom of a screw gun and a base slidably assembled inside of the guiding cover. Inside of the base, a screw feeding wheel and an oscillating member are assembled in the same axle. The oscillating member includes an off-center guiding portion slidably assembled to the guiding slot of the guiding cover. The guiding portion is guided by the guiding slot and drives the oscillating member to move. A plurality of locking grooves is provided surrounding the axle center of the screw feeding wheel. At least one locking claw bears the elastic force to be pivotally assembled to the oscillating member. The locking claw includes an off-center pushing portion. The locking claw moves accompanying with the oscillating member, drives the pushing portion to elastically contact the locking groove and therefore, drives the screw feeding wheel to rotate. The locking claw also drives the pushing portion to be separated from the locking groove and discharges the screw feeding wheel.

### BACKGROUND

1. Technical Field

The present invention relates to a feeding device of a screw gun. More particularly, the present invention relates to a guiding cover for screw feeding, a base, a screw feeding wheel of a screw belt, an oscillating member, locking grooves and locking claws configured to connect with or discharge the oscillating member.

2. Related Art

The traditional screw belt feeding device of the screw gun has been disclosed in U.S. Pat. No. 5,687,624. A guiding cover is provided at the bottom of the screw gun. The wall of the guiding cover is provided with a guiding slot for guiding two directions. A base is slidably connected with the guiding cover. A screw feeding wheel is pivotally assembled to the base. The screw feeding wheel can be a cog for moving the belt of the screws. When the base moves up and down on the guiding cover, the screw feeding wheel can indirectly be guided by the guiding slot and rotate in a single direction and in a predetermined amount. As a result, the screw belt continuously moves. A plurality of screws is driven one by one by the screw gun and contacts the work piece by threads. The screw feeding wheel can rotate in a single direction and in a predetermined amount to avoid the screw belt to be moved in an opposite direction.

In U.S. Pat. No. 5,988,025, the base can further be pivotally assembled with an oscillating member and a cog in the same axle center. The oscillating member includes an off-centered guiding portion, slidably assembled in the guiding slot and being guided by the guiding slot to drive the oscillating member to move. The cog is engaged with the screw feeding wheel. The oscillating member is elastically connected with or discharged from the cog by a plurality of locking grooves and threads and in turn, drives the screw feeding wheel to rotate or discharge the screw feeding wheel in order for the screw feeding wheel to rotate in a single direction and at a predetermined amount. The disadvantage is that the oscillating member pushes the cog while it rotates and therefore, the oscillating member moves in the two directions, which causes blockage of the oscillating member. In addition, the structure space of the screw feeding device is increased when the cog is configured to control the movement of the screw feeding wheel by engaging with or discharging the screw feeding wheel.

U.S. Pat. No. 5,988,026 has disclosed another screw feeding wheel for rotation in a single direction and at a predetermined amount. In that patent, the oscillating member and the screw feeding wheel are assembled in a single axis line. The oscillating member elastically contacts or is discharged from the screw feeding wheel by a plurality of locking grooves and ratchets. As a result, the oscillating member can drive the screw feeding wheel in the single axis line to rotate in the single direction and at a predetermined amount, which can save the structural space of the screw feeding device. The disadvantage is that the oscillating member pushes the screw feeding wheel while rotates and therefore, moves simultaneously in two directions, which causes the blockage of the oscillating member.

### BRIEF SUMMARY

The present application provides a screw feeding device of the screw gun to solve the blockage issue of the screw feeding member caused by its movement simultaneously in two directions and to smooth the operation of the screw gun. In addition, in the present application, different transition members are installed in a single axis line to save the structural space of the screw feeding device.

The present application provides a screw feeding device of a screw gun, comprising: a guiding cover assembled in the bottom of a gun body of a screw gun, a guiding slot for screw feeding being provided on the wall of the guiding cover; a base slidably assembled inside of the guiding cover; a screw feeding wheel, pivotally assembled inside of the base, capable of moving a belt of the screws to provide the screws of the belt for the screw gun; an oscillating member, including a pivotal portion and a guiding portion away from the pivotal portion, the oscillating member being pivotally assembled through the pivotal portion to the base and being in the same axle as the screw feeding wheel, the guiding portion being slidably assembled inside of the guiding slot, the oscillating member moving back and force with the base in the guiding cover and being guided by the guiding slot through the guiding portion to do the oscillation; a plurality of locking grooves, formed on the screw feeding wheel and arranged in ring shape in the outside portion of the axle center of the screw feeding wheel, the inside wall of the locking groove including a blocking surface and a tilted guiding surface in the rotation path of the screw feeding wheel, the titled guiding surface being positioned on the relative side of the blocking surface; and at least one arm-shaped locking claw, respectively including a pushing portion and an axle portion on both ends, the locking claw bearing the elastic force to pivotally assembled to the oscillating member through the axle portion and being positioned between the oscillating member and the locking groove, the pushing portion being in the rotation path, the locking claw oscillating with the oscillating member, driving the pushing portion elastically engaged in the locking groove to push the blocking surface to drive the screw feeding wheel to rotate, and driving the pushing portion to elastically separate from the locking groove to discharge the screw feeding wheel.

As mentioned above, the oscillating member may be configured to move the locking claw and the locking claw may be configured to push the screw feeding wheel, which is to overcome the blockage phenomenon of the oscillating member arising from the movement of the oscillating member simultaneously into two directions and therefore to smooth the operation of the screw gun. In addition, in the present application, the pivotal portion of the oscillating member and the screw feeding wheel may be engaged on a single axis line. The oscillating member may contact or be discharged from the screw feeding wheel by the locking groove and the locking claw and in turn, may be capable of driving the screw feeding wheel rotate in a single direction and in a predetermined amount. Therefore, this application can achieve the purpose of saving the structure space of the screw feeding device.

In addition, in the present application, the screw feeding wheel includes a wheel surface close to the oscillating member, the locking groove is formed on the wheel surface and the blocking surface and the titled guiding surface are connected with the wheel surface.

The locking claw is positioned in the oscillating member surrounding the pivotal portion.

The locking claws are arranged to form a circle and in equal intervals of the circle.

The oscillating member includes an end surface close to the locking groove, the end surface forms at least one notch and the locking claw is pivotally assembled in the notch.

The locking claw and the oscillating member has a spring in between, the locking claw bears the elastic force through the spring, and the spring drives the locking claw towards the screw feeding wheel.

The oscillating member includes a positioning aperture close to the pushing portion and the spring is provided in the positioning aperture.

The locking claw includes a positioning column close to the pushing portion and the spring is provided on the positioning column.

The pushing portion includes an inclined plane capable of contacting the tilted guiding surface.

The pushing portion is provided with an inclined plane being inclined towards the axle portion.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of one embodiment of the present invention.

FIG. 2 is a perspective view of the guiding cover and the base of FIG. 1.

FIG. 3 is a front view of FIG. 2.

FIG. 4 is a cutaway view of FIG. 3.

FIG. 5 is a prospective exploded view of a base of FIG. 2.

FIG. 6 is a prospective exploded view of a screw feeding wheel and an oscillating member of FIG. 5.

FIG. 7 is a partial amplified cutaway view of the base of FIG. 4.

FIG. 8 is an A-A cutaway view of FIG. 7.

FIG. 9 is an action view of a base of FIG. 3.

FIG. 10 is another action view of a base of FIG. 3.

FIG. 11 is an action view of FIG. 7.

FIG. 12 is another action view of FIG. 7.

FIG. 13 is another action view of the base of FIG. 3.

FIG. 14 is another action view of FIG. 7.

FIG. 15 is an action view of FIG. 8.

FIG. 16 is another action view of FIG. 8.

### DETAILED DESCRIPTION

Hereinafter, the present invention will be described in detail with reference to the accompanying drawings. It should be understood that drawings do not limit the scope of the present invention.

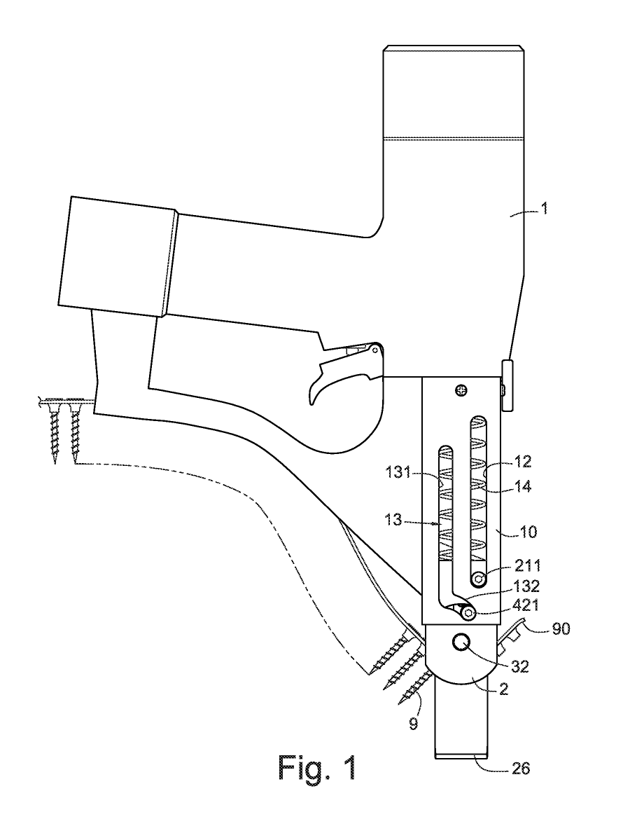

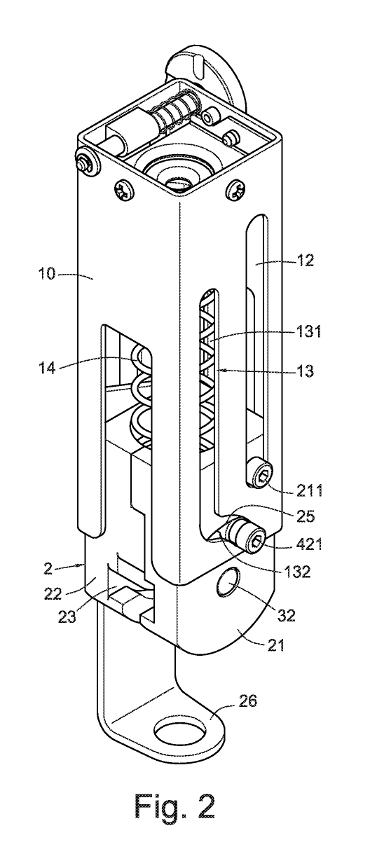

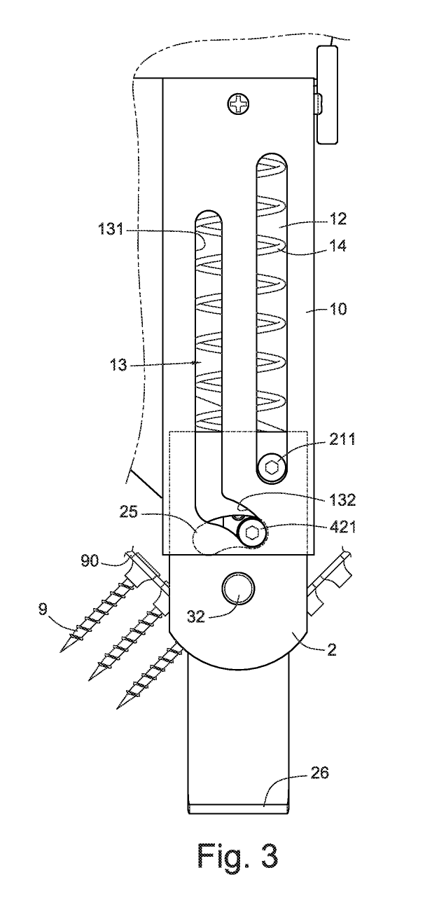

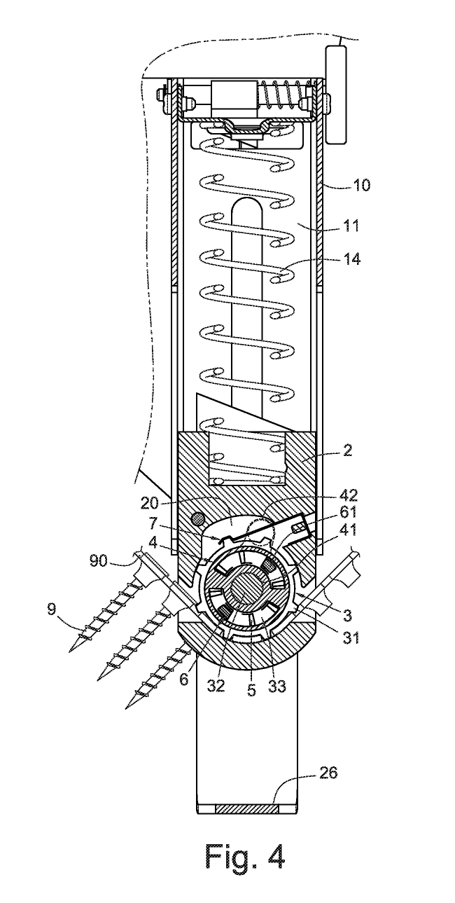

FIG. 1 is a front view of one embodiment of the present invention. As shown in FIG. 1 accompanying with FIG. 2 and FIG. 3, a feeding device of a screw gun of the present application comprises a guiding cover 10, a base 2, a screw feeding wheel 3, an oscillating member 4, a plurality of locking grooves 5 and at least one arm-shaped locking claw 6. The guiding cover 10 may be assembled at the bottom of the gun body 1 of the screw gun. The guiding cover 10 may include a vertical sliding slot 11 (as shown in FIG. 4) connected between the bottom of the gun body 1 and the bottom of the guiding cover 10. A directional groove 12 and a guiding slot 13 for feeding screws are provided on the wall of the guiding cover 10. The directional groove 12 and the guiding slot 13 may be respectively connected to the sliding slot 11. The directional groove 12 may be vertically formed between the top and the bottom walls of the guiding cover 10. The guiding slot 13 may have two guiding directions, including a vertical slot portion 131 and an oblique slot portion 132. The oblique slot portion 132 may be formed on the bottom wall of the guiding cover 10. The vertical slot portion 131 may be formed between the top and bottom walls of the guiding cover 10 and may contact the oblique slot portion 132 at the bottom wall of the guiding cover 10.

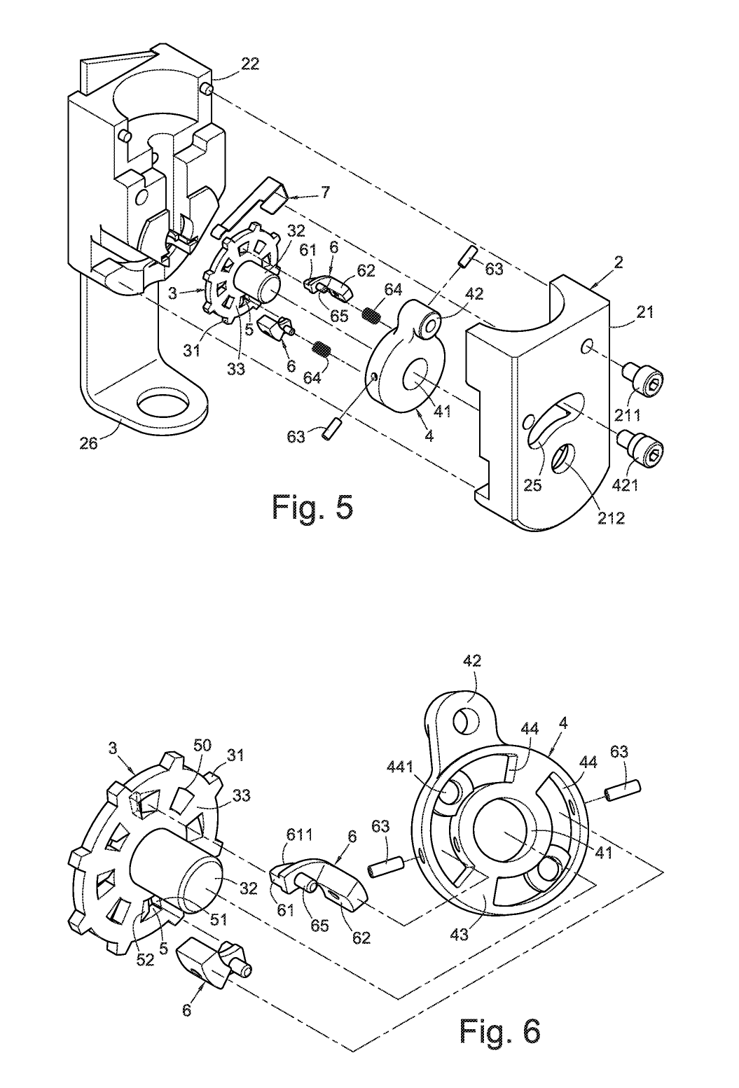

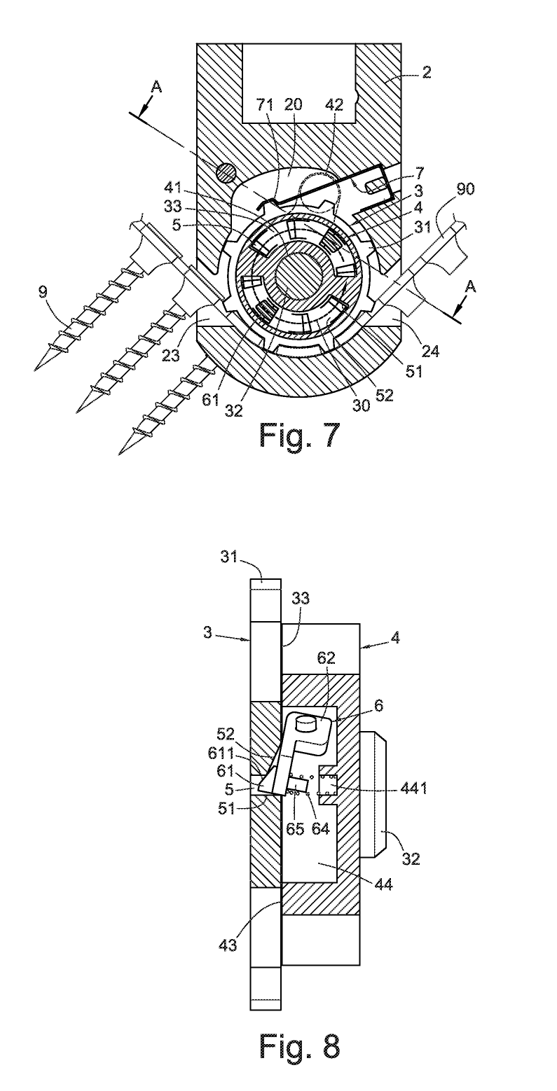

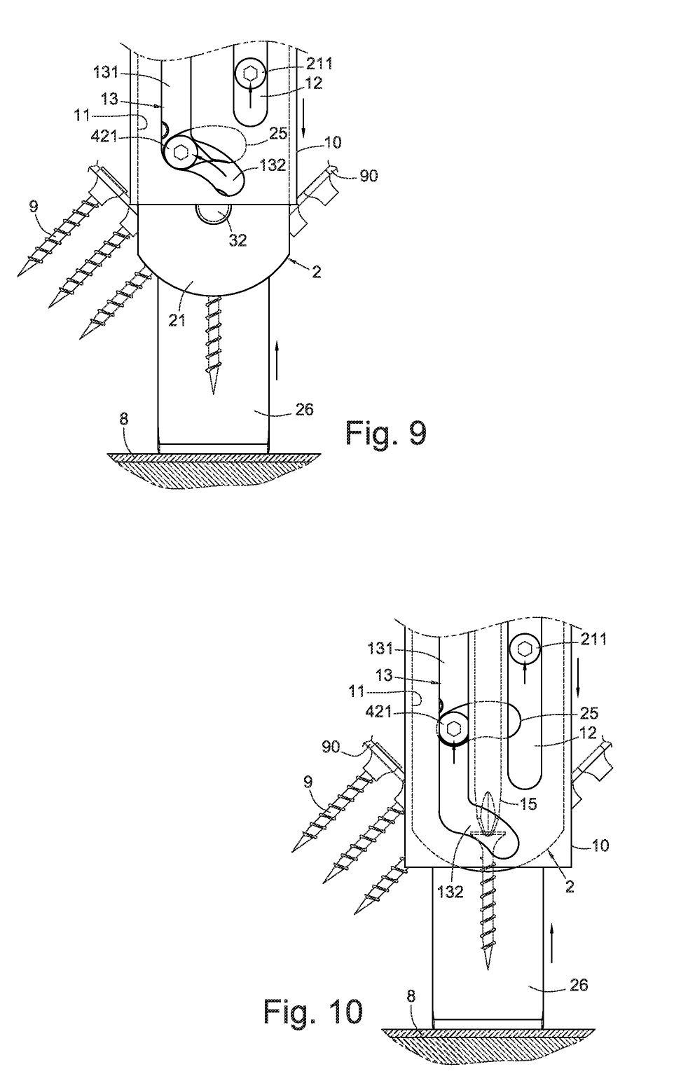

The base 2 may be a combination of a first base body 21 and a second base body 22 (as shown in FIG. 5). The base 2 may be provided with a first guiding screw bolt 211 secured to the outside wall of the first base body 21. The base 2 may be slidably assembled to the sliding slot 11 of the guiding cover 10 (as shown in FIG. 4). The first guiding screw bolt 211 may be slidably assembled to the directional groove 12. As a result, the base 2 may be capable of moving in the directional groove 12 through the first guiding screw bolt 211. The sliding slot 11 may be provided with a first spring 14 suppressed between the bottom of the gun body 1 and the top of the base 2. As a result, the base 2 may be capable of elastically extending downwards to the bottom of the guiding cover 10 and may be capable of being elastically indented upwards into the sliding slot 11 of the guiding cover 10. An installation space 20 may be provided inside of the base 2 (as shown in FIG. 7) between the first and second base body 21 and 22. The installation space 20 may respectively form a guiding entrance 23 and a guiding exit 24 of the screw belt 90 on both sides of the base 2. The screw belt 90 may include a plurality of screw heads of the screws 9 capable of moving into the installation space 20 accompanying with the screw belt 90. The base 2 may be provided with a horizontal arc slot 25 formed on the outside wall of the first base body 21. When the base 2 is still or in movement, the arc slot 25 is always capable of contacting the guiding slot 13 (as shown in FIG. 9 and FIG. 10). The base 2 may be provided with a pressing member 26 to contact with the work piece 8. The pressing member 26 may be secured to the second base body 22 and may extend to the bottom of the base 2. A screw driver 15 inside of the gun body 1 is capable of moving through the sliding slot 11 and the installation space 20 (as shown in FIG. 10) to drive the screw 9 inside of the installation space 20.

The screw feeding wheel 3 can be a cog (as shown in FIG. 5 and FIG. 6). The cog may include a plurality of guiding protrusion 31. A center axle 32 may be provided on one side of the screw feeding wheel 3. The screw feeding wheel 3 may be pivotally assembled to the installation space 20 of the base 2 through the center axle 32. In one embodiment, the outside wall of the first base body 21 may be provided with an aperture 212. The center axle 32 may be pivotally engaged with the aperture 212. The screw feeding wheel 3 may be positioned between the guiding entrance 23 and the guiding exit 24 and is capable of moving the screw belt 90 through the guiding protrusion 31 to provide the screws 9 of the screw belt 90 for the screw gun.

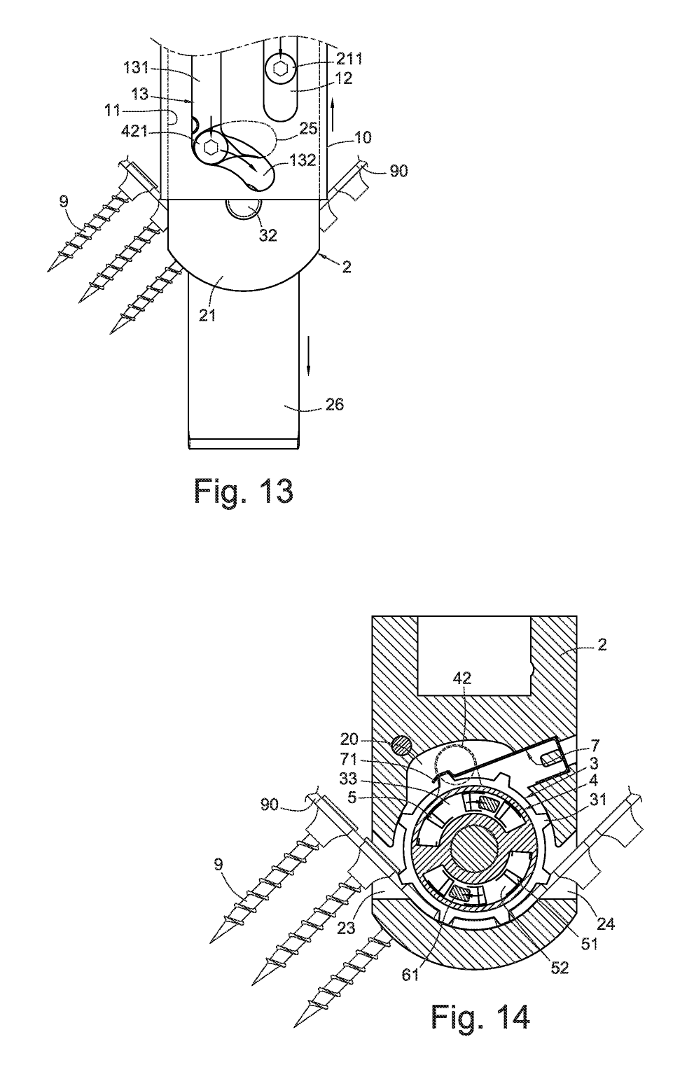

The oscillating member 4 may be in a disk-like shape (as shown in FIG. 5 and FIG. 6). The oscillating member 4 may include a pivotal portion 41 in the center of the disk and a guiding portion 42 away from the pivotal portion 41. In the present embodiment, the pivotal portion 41 may be an axle aperture. The oscillating member 4 may be assembled to the center axle 32 of the screw feeding wheel 3 through the axle aperture. As a result, the oscillating member 4 may be pivotally assembled through the pivotal portion 41 to the installation space 20 of the base 2 and in the same axle as the screw feeding wheel 3. The oscillating member 4 may be positioned between the first base body 21 and the screw feeding wheel 3. The guiding portion 42 may extend to the side of the disk. The guiding portion 42 may be assembled a second guiding screw bolt 421. The second guiding screw bolt 421 may be slidably assembled to the arc slot 25 and the guiding slot 13 (as shown in FIG. 4 and FIG. 7). As a result, the oscillating member 10 is capable of moving up and down accompanying with the base 2 (as shown in FIG. 9 and FIG. 13). Meanwhile, the oscillating member 10 is guided by the oblique slot portion 132 of the guiding slot 13 through the guiding portion 42 to move (as shown in FIG. 12 and FIG. 14).

The screw feeding wheel 3 may have a wheel surface 33 close to the oscillating member 4 (as shown in FIG. 5 and FIG. 6). The locking grooves 5 may respectively be formed on the wheel surface 33 of the screw feeding wheel 3 (as shown in FIG. 7 and FIG. 8) and arranged in a circle surrounding the axle center of the screw feeding wheel 3, that is, the locking grooves 5 may be arranged surrounding the center axle 32. The groove openings 50 of the locking grooves 5 may have a rectangle shape and may have at least two inside walls in the rotation path 30 of the screw feeding wheel 3. The inside walls may include a blocking surface 51 and a tilted guiding surface 52 in the rotation path 30. The tilted guiding surface 52 may be positioned on the opposite side of the blocking surface 51. The blocking surface 51 and the tilted guiding surface 52 may respectively contact the wheel surface 33 through the groove opening 50.

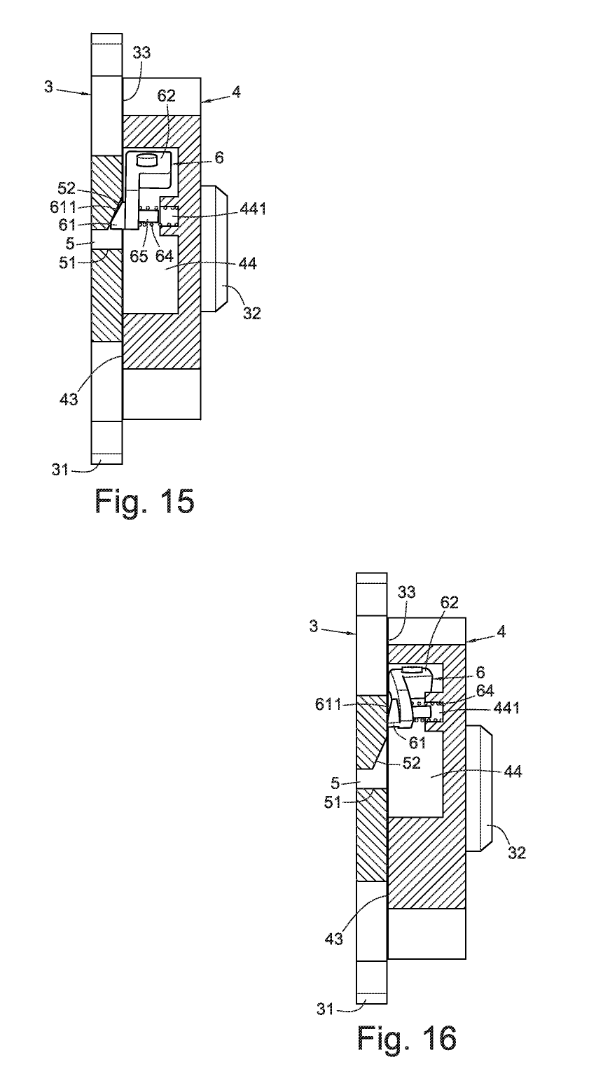

The outside portion of the pivotal portion 41 of the oscillating member 4 includes a ring-shaped end surface 43 close to the locking groove 5 (as shown in FIG. 6). The end surface 43 may form at least one notch 44. The locking claws 6 may have the same number as the notches 44. The locking claws 6 may form a pushing portion 61 and an axle portion 62 on both ends. The locking claws may bear the elastic force to be pivotally engaged with the notches 44 of the oscillating member 4 (as shown in FIG. 8) and may be positioned between the oscillating member 4 and the locking groove 5. As a result, the locking claw 6 may be positioned on the end surface 43 of the oscillating member 4 surrounding the pivotal portion 41. The pushing portion 61 may on the rotation path 30 (as shown in FIG. 7). In this embodiment, the axle portion 62 of the locking claw 6 may be pivotally engaged with the notch 44 by an axle rod 63 (as shown in FIG. 5). A second spring 64 may be provided between the locking claw 6 and the oscillating member 4. The second spring 64 may be a compression spring between the pushing portion 61 and the oscillating member 4. Alternatively, the second spring may be a torsion spring assembled to the axle portion 62 and may be suppressed between the pushing portion 61 and the oscillating member 4. As a result, the locking claw 6 may bear the elastic force from the second spring 64. The second spring 64 may drive the locking claw 6 and its pushing portion 61 to move to the direction of the wheel surface 33 of the screw feeding wheel 3. As a result, the pushing portion 61 may be elastically engaged with the locking groove 5 and may elastically push the tilted guiding surface 52 or wheel surface 33 (as shown in FIG. 15 or 16).

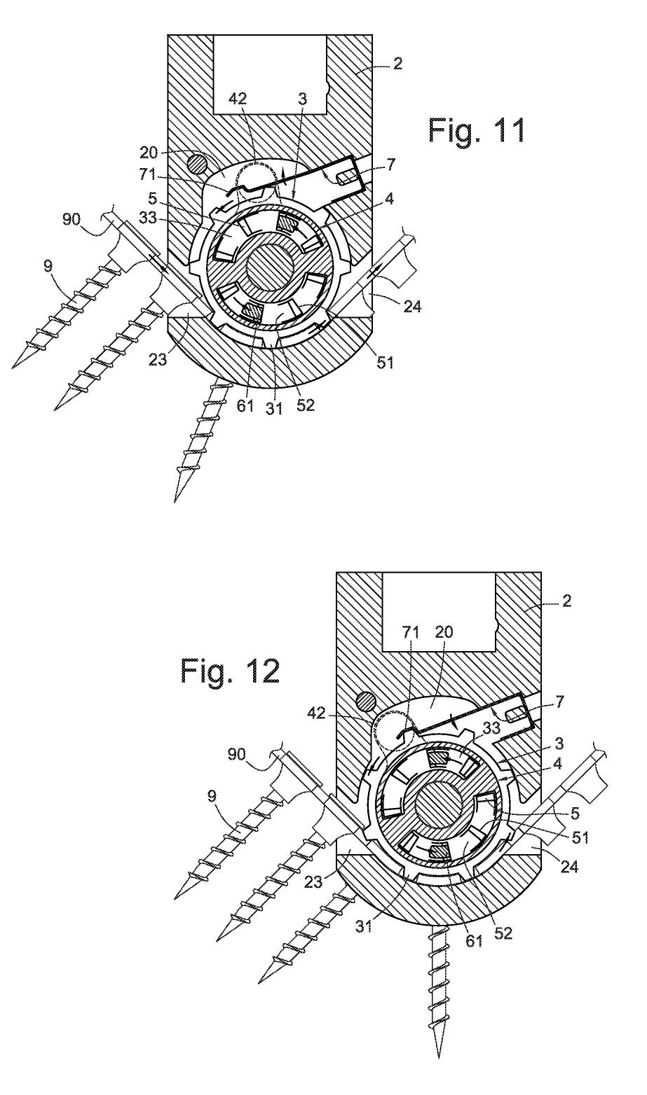

Inside of the notch 44 of the oscillating member 4 may be provided with a positioning aperture 441 close to the pushing portion 61 (as shown in FIG. 6 and FIG. 8). The locking claw 6 may be provided with a positioning column 65 close to the pushing portion 61. The second spring 64 may contact the positioning aperture 441 and the positioning column 65 on its both ends. The pushing portion 61 may form an inclined plane 611. The inclined plane 611 may be inclined in the direction of the axle portion 62. The inclined plane 611 may be capable of contacting the tilted guiding surface 52. As a result, the locking claw 6 may be capable of oscillating up and down accompanying with the oscillating member 4 and may drive the pushing portion 61 to be elastically engaged with the locking groove 5 to push the blocking surface 51 (as shown in FIG. 7, FIG. 11 and FIG. 12) and in turn, may drive the screw feeding wheel 3 to rotate and may drive the pushing portion 61 along with the inclined plane 611 and the tilted guiding surface 52 to elastically separate the locking groove 5 (as shown in FIG. 14 to FIG. 16) to discharge the screw feeding wheel 3. The locking claws 6 may be more than one and may be arranged to form in a circle and in equal intervals of the circle, which can increase the reliability of the rotation of the screw feeding wheel 3 by the locking claw 6 through the locking groove 5. In this embodiment, there are two locking claws as an example to show that two locking claws 6 may be arranged in symmetry state on the end surface 43 of the oscillating member 4.

A spring plate 7 may be provided within the installation space 20 (as shown in FIG. 5 and FIG. 7). The spring plate 7 may include a blocking portion 71 extending to the rotation path 30 of the screw feeding wheel 3. The blocking portion 71 may be positioned at the top of the installation space 20 and may face the guiding entrance 23. As a result, when the oscillating member 4 drives the screw feeding wheel 3 to rotate in the screw feeding direction (as shown in FIG. 11 and FIG. 12), the blocking portion 71 is capable of being pushed by the guiding protrusion 31 to create the elastic deflection, which may discharge the guiding protrusion 31 to get across. The screw feeding direction may mean the rotation direction of the screw feeding wheel 3 which drives the screw belt 90 from the guiding entrance 23 into the installation space 20 and in turn to leave the installation space 20 from the guiding exit 24. When the oscillating member 4 may move towards against the screw feeding direction, the blocking portion 71 is capable of blocking the guiding protrusion 31 and in turn, blocking the screw feeding wheel 3.

The above structure can be operated as followings. When the pressing member 26 of the screw gun contacts the work piece 8 (as shown in FIG. 9) and the gun body 1 moves downwards, the base 2 may move relatively upwards along the sliding slot 11. In turn, the guiding portion 42 of the oscillating member 4 may be guided by the arc slot 25 and the oblique slot portion 132 of the guiding slot 13 through the second guiding screw bolt 421. As a result, the oscillating member 4 may be driven towards the screw feeding direction (as shown in 11). During the movement, the blocking portion 71 of the spring plate 7 may discharge the guiding protrusion 31. The pushing portion 61 of the locking claw 6 may be elastically engaged with the locking groove 5 (as shown in FIG. 8). The pushing portion 61 may move in the screw feeding direction accompanying with the oscillating member 4, push the blocking surface 51 along the rotation path 30 and in turn, drive the screw feeding wheel 3 to rotate in the screw feeding direction (as shown in FIG. 12). As a result, the screw feeding wheel 3 may move the screw belt 90 from the guiding entrance 23 into the installation space 20 and in turn, may move the screw belt 90 out of the installation space 20 from the guiding exit 24, and therefore move the head of the screws 9 of the screw belt 90 into the installation space 20. Afterwards, the gun body 1 may move continuously downwards (as shown in FIG. 10). The guiding portion 42 may be guided by the vertical slot portion 131 of the guiding slot 13 through the second guiding screw bolt 421, and in turn the base 2 may continuously move upwards along the sliding slot 11. Hereafter, the screw driver 15 of the screw gun may move through the sliding slot 11 to reach the installation space 20 and in turn, drive the screw 9 in the installation space into the work piece 8.

When the screw driver 15 moves upwards along with the gun body 1 and the pressing piece 26 contacts the work piece 8 and moves downwards relative to the gun body 1 (as shown in FIG. 13), the base 2 may move downwards along the sliding slot 11. As a result, the guiding portion 42 may be guided by the vertical slot portion 131 of the guiding slot 13 and in turn, by the oblique slot portion 132 of the guiding slot 13 through the second guiding screw bolt 421. The oscillating member 4 may be driven to move in the opposite direction of the screw feeding direction (as shown in FIG. 14). During the movement, the blocking portion 71 of the spring plate 7 may block the guiding protrusion 31 and therefore block the belt feeding wheel 3. The pushing portion 61 of the locking claw 6 may move in the opposite direction of the screw feeding direction accompanying with the oscillating member 4. As a result, the pushing portion 61 of the locking claw 6 may elastically separate from the locking groove 5 along the tilted guiding surface 52 through the inclined plane 611 (as shown in FIG. 15 and FIG. 16) and in turn, discharge the screw feeding wheel 3. Afterwards, the pushing portion 61 of the locking claw 6 may move in the opposite direction of the screw feeding direction accompanying with the oscillating member 4, and may elastically move in the next locking groove 5 (as shown in FIG. 7 and FIG. 8) waiting for driving the screw feeding wheel 3.

As mentioned above, the oscillating member 4 may be configured to move the locking claw 6. The locking claw 6 may be configured to push the screw feeding wheel 3. As a result, the blockage phenomenon of the oscillating member arising from the movement of the oscillating member simultaneously into two directions may be overcome. Therefore, the smoothness of the operation of the screw gun may be increased. In addition, in the present application, the pivotal portion 41 of the oscillating member 4 and the screw feeding wheel 3 may be engaged on a single axis line. The oscillating member 4 may contact or be discharged from the screw feeding wheel 3 by the locking groove 5 and the locking claw 6 and in turn, may be capable of driving the screw feeding wheel to rotate in a single direction and in a predetermined amount. Therefore, this application can achieve the purpose of saving the structure space of the screw feeding device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A screw feeding device of a screw gun, comprising:
a guiding cover assembled in the bottom of a gun body of a screw gun, a guiding slot for screw feeding being provided on the wall of the guiding cover;
a base slidably assembled inside of the guiding cover;
a screw feeding wheel, pivotally assembled inside of the base, capable of moving a belt of the screws to provide the screws of the belt for the screw gun;
an oscillating member, including a pivotal portion and a guiding portion away from the pivotal portion, the oscillating member being pivotally assembled through the pivotal portion to the base and being in the same axle as the screw feeding wheel, the guiding portion being slidably assembled inside of the guiding slot, the oscillating member moving back and force with the base in the guiding cover and being guided by the guiding slot through the guiding portion to do the oscillation;
a plurality of locking grooves, formed on the screw feeding wheel and arranged in a circle in the outside portion of the axle center of the screw feeding wheel, the inside wall of the locking groove including a blocking surface and a tilted guiding surface in the rotation path of the screw feeding wheel, the titled guiding surface being positioned on the opposite side of the blocking surface; and
at least one arm-shaped locking claw, respectively including a pushing portion and an axle portion on both ends, the locking claw bearing the elastic force to pivotally assembled to the oscillating member through the axle portion and being positioned between the oscillating member and the locking groove, the pushing portion being in the rotation path, the locking claw oscillating with the oscillating member, driving the pushing portion elastically engaged in the locking groove to push the blocking surface to drive the screw feeding wheel to rotate, and driving the pushing portion to elastically separate from the locking groove to discharge the screw feeding wheel.

2. The screw feeding device according to claim 1, wherein the screw feeding wheel includes a wheel surface close to the oscillating member, the locking groove is formed on the wheel surface and the blocking surface and the titled guiding surface are connected with the wheel surface.

3. The screw feeding device according to claim 1, wherein the locking claw is positioned in the oscillating member surrounding the pivotal portion.

4. The screw feeding device according to claim 3, wherein the locking claws are arranged to form a circle and in equal intervals of the circle.

5. The screw feeding device according to claim 2, wherein the oscillating member includes an end surface close to the locking groove, the end surface forms at least one notch and the locking claw is pivotally assembled in the notch.

6. The screw feeding device according to claim 1, wherein the locking claw and the oscillating member has a spring in between, the locking claw bears the elastic force through the spring, and the spring drives the locking claw towards the screw feeding wheel.

7. The screw feeding device according to claim 6, wherein the oscillating member includes a positioning aperture close to the pushing portion and the spring is provided in the positioning aperture.

8. The screw feeding device according to claim 6, wherein the locking claw includes a positioning column close to the pushing portion and the spring is provided on the positioning column.

9. The screw feeding device according to claim 1, wherein the pushing portion includes an inclined plane capable of contacting the tilted guiding surface.

10. The screw feeding device according to claim 1, wherein the pushing portion is provided with an inclined plane being inclined towards the axle portion.
